(19) United States
(12) Patent Application Publication
(10) Pub. No.: US 2026/0073483 A1
(43) Pub. Date: Mar. 12, 2026

(54) METHOD AND ELECTRONIC DEVICE FOR SYNTHESIZING VIDEO

(71) Applicant: Samsung Electronics Co., Ltd., Suwon-si (KR)

(72) Inventors: Kirill Vladislavovich DEMOCHKIN, Novgorod (RU); Konstantin Victorovich SOBOLEV, Kirov (RU); Arsen Rinatovich KUZHAMURATOV, Dolgoprud- ny (RU); Svetlana Alexandrovna GABDULLINA, Bataisk (RU); Alexey Stanislavovich CHERNYAVSKIY, Moscow (RU)

(21) Appl. No.: 19/394,259

(22) Filed: Nov. 19, 2025

Related U.S. Application Data
(63) Continuation of application No. PCT/KR2024/005723, filed on Apr. 26, 2024.

(30) Foreign Application Priority Data
May 22, 2023 (RU) 2023113196
Sep. 12, 2023 (RU) 2023123582

(51) Int. Cl. G06T 5/60; G06T 5/50; G06T 5/70; G06T 7/00; G06T 7/246

(52) U.S. Cl. CPC G06T 5/60; G06T 5/50; G06T 5/70; G06T 7/0002; G06T 7/246; G06T 2207/10016; G06T 2207/20081; G06T 2207/20084; G06T 2207/20212; G06T 2207/30168

(57) ABSTRACT

A method for synthesizing a video is provided. The method includes obtaining a shared motion latent code corresponding to a motion between frames of the video by inputting an input frame to a first encoder, obtaining a first latent representation by inputting the input frame to a second encoder to reduce a resolution of the input frame, and predicting, by using a trained neural network model, a next frame from the input frame based on the shared motion latent code and the first latent representation.

### CROSS-REFERENCE TO RELATED APPLICATION(S)

This application is a continuation application, claiming priority under 35 U.S.C. § 365 (c), of an International application No. PCT/KR2024/005723, filed on Apr. 26, 2024, which is based on and claims the benefit of a Russian patent application number 2023113196, filed on May 22, 2023, in the Rospatent Federal Service for Intellectual Property, and of a Rospatent application No. 2023123582, filed on Sep. 12, 2023, in the Ros patent Federal Service for Intellectual Property, the disclosure of each of which is incorporated by reference herein in its entirety.

### BACKGROUND

### 1. Field

The disclosure relates to autoregressive synthesis of high-quality videos from a single frame (image) using fully-convolutional diffusion model.

### 2. Description of Related Art

Video synthesis, a critical research area in computer vision and graphics, has widespread potential applications from personalized content creation to computer-generated imagery (CGI) effects. Although recent advancements have improved the quality of image synthesis, high-resolution image-to-video animation remains a formidable challenge. The primary reason is that existing models necessitate large-scale video datasets and substantial computational resources, making them expensive to train and limiting their practicality.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to use a diffusion-based frame-to-next-frame model that in fact is a diffusion-based frame-to-video model with recursive frame sampling scheme and explicit motion control of the videos being synthesized via shared motion latent code. Advantageously, the technical solutions proposed and disclosed herein thus allow to maintain temporal coherence of the videos being synthesized. Moreover, application of the diffusion-based frame-to-video model with the recursive frame sampling scheme and explicit motion control makes it possible to train the model on lower resolution videos, using less video random access memory (VRAM) and then, when trained, use it for inference in higher resolution (e.g., up to 2048×1280) without significant reduction in image quality.

Additional aspects will be set forth in part in the description which follows and, in part, will be apparent from the description, or may be learned by practice of the presented embodiments.

In accordance with an aspect of the disclosure, a method for synthesizing a video is provided. The method includes obtaining a shared motion latent code corresponding to a motion between frames of the video by inputting an input frame to a first encoder, obtaining a first latent representation by inputting the input frame to a second encoder to reduce a resolution of the input frame, predicting, by using a trained neural network model, a next frame from the input frame based on the shared motion latent code and the first latent representation.

In accordance with another aspect of the disclosure, an electronic device for synthesizing a video is provided. The electronic device includes memory, including one or more storage media, storing instructions and at least one processor communicatively coupled to the memory, wherein the instructions when executed individually or collectively by the at least one processor, cause the electronic device to obtain a shared motion latent code associated with a motion between frames of the video by inputting an input frame to a first encoder, obtain a first latent representation by inputting the input frame to a second encoder to reduce a resolution of the input frame, and predict, by using a trained neural network model, a next frame from the input frame based on the shared motion latent code and the first latent representation.

In accordance with another aspect of the disclosure, one or more non-transitory computer-readable storage media storing one or more computer programs including computer-executable instructions that, when executed by individually or collectively by at least one processor of an electronic device cause the electronic device to perform operations are provided. The operations include obtaining a shared motion latent code corresponding to a motion between frames of a video by inputting an input frame to a first encoder, obtaining a first latent representation by inputting the input frame to a second encoder to reduce a resolution of the input frame, and predicting, by using a trained neural network model, a next frame from the input frame based on the shared motion latent code and the first latent representation.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an architecture of a diffusion-based frame-to-next-frame model according to an embodiment of the disclosure;

FIG. 2 illustrates a structure of a trained neural network comprised in a diffusion-based frame-to-next-frame model according to an embodiment of the disclosure;

FIG. 3 illustrates a motion latent code sampling process performed by a diffusion-based frame-to-next-frame model according to an embodiment of the disclosure;

FIG. 4 illustrates frames synthesized in an autoregressive way starting from an input frame with a diffusion-based frame-to-next-frame model according to an embodiment of the disclosure; and

FIG. 5 illustrates a method for synthesizing video according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

Further, skilled artisans will appreciate that elements in the drawings are illustrated for simplicity and may not have necessarily been drawn to scale. For example, the flowcharts illustrate the method in terms of the most prominent steps involved to help to improve understanding of aspects of the disclosure. Furthermore, in terms of the construction of the device, one or more components of the device may have been represented in the drawings by symbols of the related art, and the drawings may show only those specific details that are pertinent to understanding the embodiments of the disclosure so as not to obscure the drawings with details that will be readily apparent to those of ordinary skill in the art having the benefit of the description herein.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “some” as used herein is defined as “none, or one, or more than one, or all.” Accordingly, the terms “none,” “one,” “more than one,” “more than one, but not all” or “all” would all fall under the definition of “some.” The term “some embodiments” may refer to no embodiments or one embodiment or several embodiments or all embodiments. Accordingly, the term “some embodiments” is defined as meaning “no embodiment, or one embodiment, or more than one embodiment, or all embodiments.”

The terminology and structure employed herein are for describing, teaching, and illuminating some embodiments and their specific features and elements and do not limit, restrict, or reduce the spirit and scope of the claims or their equivalents.

More specifically, any terms used herein, such as but not limited to “includes,” “comprises,” “has,” “consists,” and grammatical variants thereof do not specify an exact limitation or restriction and certainly do not exclude the possible addition of one or more features or elements, unless otherwise stated, and must not be taken to exclude the possible removal of one or more of the listed features and elements, unless otherwise stated.

Whether or not a certain feature or element was limited to being used only once, either way, it may still be referred to as “one or more features” or “one or more elements” or “at least one feature” or “at least one element.” Furthermore, the use of the terms “one or more” or “at least one” feature or element do not preclude there being none of that feature or element unless otherwise stated. Thus, at least one of A, B or C may be referred to as “only a”, “only b”, “only c”, “both a and b”, “both a and c”, “both b and c”, “all of a, b, and c”, or variations thereof.

It should be appreciated that the blocks in each flowchart and combinations of the flowcharts may be performed by one or more computer programs which include instructions. The entirety of the one or more computer programs may be stored in single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphics processing unit (GPU), a neural processing unit (NPU), (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

Unless otherwise defined, all terms, and especially any technical and/or scientific terms, used herein may be taken to have the same meaning as commonly understood by one having ordinary skill in the art.

“Diffusion model” may refers to a neural network model including a class of generative models used for generating complex data distributions and generate new data samples.

“Attention” refers to a mechanism or technique that helps neural network model focus on specific parts of input data.

“Conditioning motion” refers to the process of taking into account the motion information from the input frames to make predictions about the motion and appearance of the next frame in diffusion models for predicting the next frame in a video sequence.

“A U-Net” may refer to a neural network model including an encoder and a decoder, with a bottleneck or bridge in between.

“A shared motion latent code” may refer to a data representing encoded motion patterns among objects or entities in video frames.

“A latent representation” may refer to a data representing an encoded frame for reducing spatial resolution of the frame.

“A pre-trained variational autoencoder (VAE)” is a neural network model that has been trained on a large dataset before being fine-tuned or adapted for a specific task or application.

“Embedding” may refers to the process of mapping data, often in the form of discrete or categorical variables, into a continuous, lower-dimensional space.

“A bank” may refer to a component or layer in the neural network model architecture that is responsible for handling embeddings. In an embodiment of the disclosure, the bank of learned motion embeddings is stored in motion embedding layer.

The technical solutions proposed and disclosed herein perform video synthesis task in an autoregressive way by conditioning the synthesis of a next frame by an input frame and, additionally, by shared motion latent code determined once for an input frame and kept constant for all synthesized frames. The shared motion latent code is a trainable vector that learns the motion dynamics of a video. The architecture of the diffusion-based frame-to-next-frame model synthesizing the frames requires only the current video frame to synthesize the next one, and thus ensures data-efficient and computationally-efficient training at high resolutions. Additionally, by conditioning all synthesized frames on a shared motion latent code, the diffusion-based frame-to-next-frame model achieves temporal consistency without memory-intensive temporal attention or temporal convolution layers.

The effectiveness of the proposed diffusion-based frame-to-next-frame model was acknowledged experimentally on well-known video synthesis datasets, such as SkyTimeLapse and DeepLandscape, using Frechet video distance (FVD) and Frechet inception distance (FID) as the main evaluation metrics. Experimental data obtained are given in the end of this detailed specification. By being trained on videos having the resolution 1280×720 the proposed diffusion-based frame-to-next-frame model is able to produce videos in up to 2 times higher resolution than current state-of-the-art techniques obtaining only a slight trade-off in FVD.

The main contributions of the patent application over the prior art are the technical solutions proposed and disclosed herein, which are devised with the understanding that complex temporal coherence mechanisms, such as temporal attention and temporal convolution layers are unnecessary for smaller video datasets and that lighter models with a recursive sampling scheme can compete with the more powerful models on smaller training datasets. Thus, the diffusion-based frame-to-next-frame model used in the technical solutions proposed and disclosed herein represents a new class of video-diffusion models that consists of a latent diffusion model (LDM) that is conditioned by an input frame of a video being synthesized and a shared latent motion code that is jointly learned for each video.

Diffusion models are a class of models often used in generative image modeling. According to one existing formulation, denoising diffusion probabilistic models (DDPMs) are latent variable models of the form p_{θ}(x₀): =∫p_{θ}(x_{0:T})d×_{1:T}, where x₁, . . . , x_{T} are latent variables of the same dimensionality as the data x₀˜q(x₀). The diffusion process, or the forward process, is a Markov chain with Gaussian transitions. It gradually adds Gaussian noise to the data according to a variance schedule β₁, . . . , β_{T}.

$$q ( {x}_{1 : T} \vert {x}_{0} ) := {\prod }_{t = 1}^{T} q ( {x}_{t} \vert {x}_{t - 1} ) , \\ q ( {x}_{t} \vert {x}_{t - 1} ) := 𝒩 ( {x}_{t} ; \sqrt{1 - {β}_{t}} {x}_{t - 1} , {β}_{t} I ) \qquad Equation l$$

Sampling xₜ at an arbitrary timestep t during the forward process can also be done in closed form:

$$\begin{matrix}q ( {x}_{ι} \vert {x}_{0} ) = 𝒩 ( {x}_{t} ; \sqrt{{\overline{α}}_{t}} {x}_{0} , ( 1 - {\overline{α}}_{t} ) I ) , \\ where {\overline{α}}_{t} := {\prod }_{s = 1}^{t} {α}_{s} and {α}_{t} := 1 - {β}_{t} .\end{matrix} \qquad Equation 2$$

The generative process, or the reverse process, is the joint distribution p_{θ}(x_{0:T}) also defined as a Markov chain with learned Gaussian transitions starting at p(x_{T})= [symbol] (x_{T};0,I).

$${p}_{θ} ( {x}_{0 : T} ) := p ( {x}_{T} ) {\prod }_{t = 1}^{T} {p}_{θ} ( {x}_{t - 1} \vert {x}_{t} ) , \qquad Equation 3$$

$${p}_{θ} ( {x}_{t - 1} \vert {x}_{t} ) := 𝒩 ( {x}_{t - 1} , {μ}_{θ} ( {x}_{t} , t ) , {\sum }_{θ} ( {x}_{t} , t ) )$$

Learning the reverse process is equal to learning to denoise xₜ˜q(xₜ|x₀) into an estimate \hat{x}_{θ}(xₜ)≈x₀ for all timesteps t. Thus, the proposed diffusion-based frame-to-next-frame model is optimized (trained) by minimizing a noise-prediction mean squared error loss (also referred to as L2 loss):

$$ℒ = {𝔼}_{ϵ , t} [ {‖ {\hat{ϵ}}_{θ} ( {x}_{t} ) - ϵ ‖}_{2}^{2} ] \qquad Equation 4$$

over times t uniformly sampled from [1, . . . , T], where \sqrt{xₜ=aₜₓ_{₀}}+\sqrt{1−a_{tϵ}} and \hat{ϵ}_{θ}(xₜ) and is the added noise ϵ predicted by the model estimation.

In an embodiment of the disclosure, a latent representation is obtained by inputting the input frame to a second encoder 102 to reduce a resolution of the input frame. In an embodiment of the disclosure, the second encoder includes an encoder E of a pre-trained variational autoencoder (VAE). To generate higher-resolution videos, adopted herein is the LDM approach. Utilizing a second encoder E 102 of a pre-trained VAE from Stable Diffusion all the data processed (at both training and inference stages) by the diffusion-based frame-to-next-frame model are encoded to reduce the spatial resolution. In the particular non-limiting implementation of the encoding the spatial resolution is reduced by X8. Using the learned latent space, latent representations of the frames synthesized by the diffusion-based frame-to-next-frame model are then decodable by a decoder D of the same VAE back to the pixel space (i.e., into actually synthesized frames). This feature provides the possibility of implementing the proposed technical solutions on devices with limited processor and memory resources.

Beside unconditional generation, diffusion models are capable of modeling conditional distributions and addressing such tasks as class-conditional image synthesis, text-to-image or text-to-video generation, image inpainting and various other image-to-image translation tasks. To synthesize video with consecutive frames the diffusion-based frame-to-next-frame model disclosed herein is conditioned on an input frame and, additionally, on a video-specific motion latent code. More particularly, a conditioning frame is concatenated with the latent representation xₜ and provided them jointly to the diffusion-based frame-to-next-frame model trained to synthesize a latent representation xₜ₊₁ decodable by the decoder D of the VAE into a next frame.

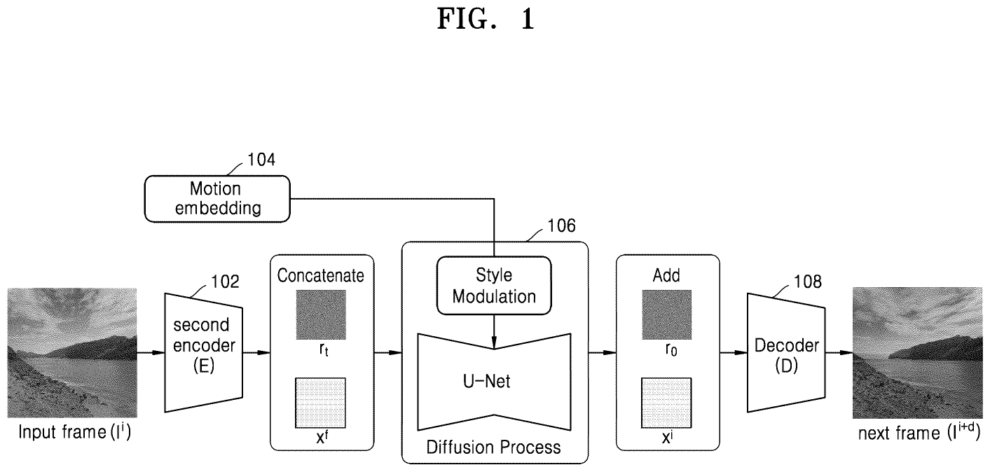

FIG. 1 illustrates an architecture of a diffusion-based frame-to-next-frame model according to an embodiment of the disclosure.

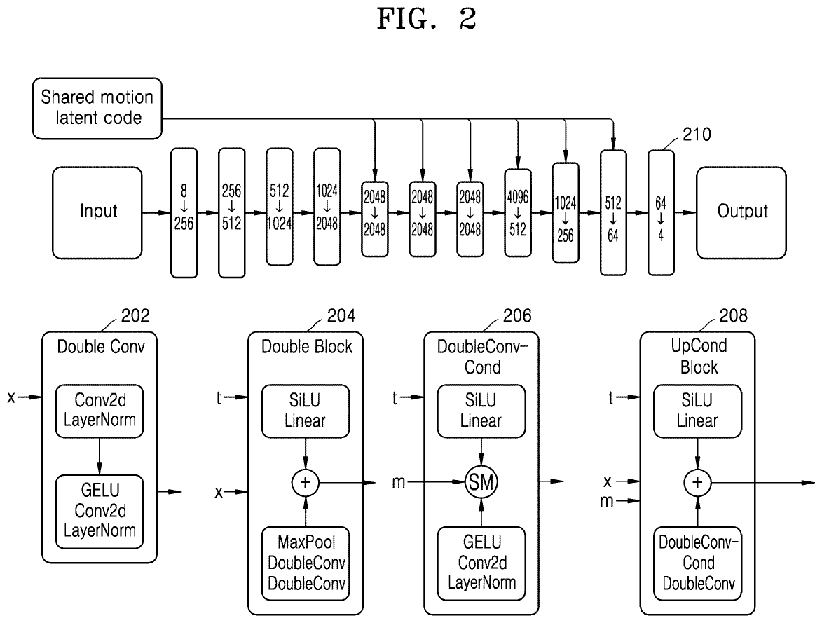

Referring to FIG. 1, the architecture of the diffusion-based frame-to-next-frame model according to a non-limiting embodiment of the disclosure will be described below. The diffusion-based frame-to-next-frame model comprises the second encoder E 102 and decoder D 108 of the pretrained VAE, a trained neural network model, and shared motion latent code m obtained by motion embedding 104 and style modulation. In an embodiment of the disclosure, the neural network model includes U-Net-based diffusion predictor. The architecture of the proposed U-Net-based diffusion predictor will be described below with reference to FIG. 2.

The diffusion-based frame-to-next-frame model does not rely on temporal attention, temporal convolution, or any other operation that explicitly propagate information across video frames. To maintain temporal coherence, the video is synthesized in an autoregressive way, frame-by-frame, by predicting the next frame I^{i+d} from the input frame Iⁱ and shared motion latent code m that is the same for all frames in a single video. At inference, I⁰ is the initial frame input to the diffusion-based frame-to-next-frame model. To synthesize high-resolution videos, the diffusion-based frame-to-next-frame model is configured to operate in a low-dimensional latent space of the pre-trained VAE being the perceptual compression model. This VAE consists of the second encoder E 102 and a decoder D 108. The VAE is pretrained in advance on the task of random frames autoencoding, i.e., an input training frame passes through the second encoder E 102, becomes a latent representation, and returns back its original pixel space after passing through the decoder D 108. The second encoder 102 and decoder 108 may be trained, but without the limitation, with a loss function computed between the original ground-truth original frame and a reconstructed frame obtained by the decoder D 108. Alternatively, the VAE including the second encoder E 102 and the decoder D 108 may be trained in an end-to-end manner with the U-Net-based diffusion predictor comprised in the diffusion-based frame-to-next-frame model to compress input frames and reconstruct synthesized frames. To train the diffusion-based frame-to-next-frame model pairs of frames

$${I}_{n}^{i} and {I}_{n}^{i + d}$$

are randomly sampled at each pass of the model from a training video of the training dataset, where d denotes the video time delta between the sampled frames. In an embodiment of the disclosure, the pairs of frames may include input frame and next frame. Training dataset may comprise any available videos, e.g., videos of people, clouds, waves, tree foliage, or the like.

It is known that at least certain adjacent frames (e.g., frames of substantially a same scene) in videos are often similar to one another and will accumulate change as they get further from the starting (initial) frame of the adjacent frames. Considering this, next (synthesized) frame latent representation x^{i+d} is modeled by the technical solutions as the sum of the input frame latent representation xⁱ and the residual

$${r}_{0}^{i}$$

predicted by the U-Net-based diffusion predictor (named as “U-Net” in FIG. 1) comprised in the diffusion-based frame-to-next-frame model:

$${x}^{i \vert d} = {x}^{i} + {r}_{0}^{i \vert d} , \qquad Equation 5$$

where d denotes the video time delta between input frame

$${I}_{n}^{i}$$

and predicted frame

$${I}_{n}^{i + d} .$$

The residual is predicted by the U-Net-based diffusion predictor predicted frame (LDM) as follows:

$${r}_{0}^{i} = DP ( {f}_{θ} ( {r}_{T}^{i \vert d} , {x}^{i} , m )$$

where DP is the diffusion process 106 described above with reference to Equations 1 to 4 above and implemented by the U-Net-based diffusion predictor f, θ denotes obtained-by-training weights of f,

$${r}_{T}^{i + d}$$

is a starting noise sampled from normal distribution ˜N(0,I). xⁱ is conditioning input frame latent representation, and m is the shared motion latent code. In an embodiment of the disclosure, input frame the latent representation xⁱ may be a first latent representation and the next frame latent representation x^{i+d} may be a second latent representation.

While the nature of motion found in videos can vary significantly between various domains, e.g., facial animation and landscape animation, within the scope of this patent application, it is assumed that the motion pattern of the objects in videos from a single domain, i.e., people, clouds, waves, tree foliage, or the like, is describable by a shared motion latent code m, which is jointly learned for each video in the training dataset and applied in f_{θ} with style modulation. In a non-limiting implementation the shared motion latent code m may be in the form of a vector of size k. Experimental data given below in the end of the specification are obtained with k being set to 16. However, depending on different circumstances (e.g., depending on currently available memory or processor resources) the size k of the vector of the low-dimensional motion latent code m may be set to higher or lower value than 16. Utilizing the shared motion latent code m is essential for synthesizing videos of favorable quality, in which motion type, speed, and direction are maintained (due to conditioning of inference by the shared motion latent code m) consistent throughout synthesized frames.

Consistent with the above description an overview of the architecture of the diffusion-based frame-to-next-frame model according to an embodiment of the disclosure is schematically illustrated in FIG. 1. As follows from FIG. 1 the pipeline comprises at least the following operations of: projecting the input frame Iⁱ from pixel space to latent vector space by passing the input frame Iⁱ through the second encoder E 102 of the VAE, as the result of the operation the first latent representation xⁱ of the input frame Iⁱ is obtained, then concatenating the initial noised residual rₜ (being the noise sampled from the normal distribution) with the first latent representation xⁱ of the input frame Iⁱ and passing the result of the concatenation through the U-Net-based diffusion predictor while conditioning motion between the frames of the video being synthesized with the shared motion latent code m (depicted in FIG. 1 as “Style Modulation” block), as the result of the operation the denoised residual r₀ is predicted by the U-Net-based diffusion predictor, then the predicted denoised residual r₀ is added to the first latent representation of the input frame to model the second latent representation x^{i+d} of the next frame I^{i+d}, and finally, the second latent representation x^{i+d} is projected back to the pixel space by the decoder D 108 of the VAE to obtain the synthesized next frame I^{i+d}.

A detailed but not limiting implementation of the architecture of the U-Net-based diffusion predictor comprised in the diffusion-based frame-to-next-frame model according to an embodiment of the disclosure is illustrated in FIG. 2 and described below. It will be understood by a skilled person in the art that the number the number of blocks and channels in the illustrated U-Net-based diffusion predictor may vary to lighten the model or make it more powerful for learning a more extensive dataset.

FIG. 2 illustrates structure of the trained neural network comprised in the diffusion-based frame-to-next-frame model according to an embodiment of the disclosure. In an embodiment of the disclosure, the trained neural network includes the U-Net-based diffusion predictor.

The U-Net-based diffusion predictor comprises blocks of five types: (1) DoubleConv block 202, (2) DownBlock block 204, (3) DoubleConvCond block 206, (4) UpCondBlock block 208, (5) 64->4 block 210.

The first block of the U-Net-based diffusion predictor, which is namely the (1) DoubleConv block 202, operates on the latent representation xⁱ of the input frame Iⁱ concatenated with the initial noised residual rₜ. The DoubleConv block 202 comprises a sub-block of 3×3 2D convolution (Conv2d) with layer normalization (LayerNorm) followed by a sub-block of Gaussian error linear unit (GELU) activation function with additional 3×3 2D convolution (Conv2d) and layer normalization (LayerNorm). The input channel size of the DoubleConv block 202 is 8, the output channel size of the DoubleConv block 202 is 256.

The second block of the U-Net-based diffusion predictor, which is namely the (2) DownBlock block 204, operates on the output of the first block and additionally on a current diffusion timestep index t which is drawn into the DownBlock block 204 via sine and/or cosine positional encoding. The DownBlock block 204 comprises a sub-block of sigmoid linear unit (SiLU) activation function and a sub-block of max pooling (MaxPool) followed by x2 DoubleConv, which contents correspond to the contents of the DoubleConv block 202 described above. The resulted data of the sub-blocks are summed up and passed to the next block of the U-Net-based diffusion predictor. The input channel size of the second DownBlock block 204 is 256, the output channel size of the second DownBlock block 204 is 512.

The third and fourth blocks of the U-Net-based diffusion predictor are each the same as the above described DownBlock block 204. Thus, the description of contents of the blocks is omitted herein. The input channel size of the third DownBlock block 204 is 512, the output channel size of the third DownBlock block 204 is 1024. The input channel size of the fourth DownBlock block 204 is thus 1024, the output channel size of the fourth DownBlock block 204 is 2048. The second, third, and fourth DownBlock block 204s are further each connected via a respective skip connection y=GELU (x+block(x)) respectively to the eighth, ninth and tenth UpCondBlock block 208s described below.

The fifth block of the U-Net-based diffusion predictor, which is namely the (3) DoubleConvCond block 206, operates on the output of the fourth block and additionally on the motion latent code m. The DoubleConvCond comprises the same contents as the DoubleConv block 202 described above and additionally a sub-block of Style (including Motion) Modulation (SM). The description of contents of the sub-blocks of the DoubleConv block 202 is omitted herein. The sub-block of SM is used in the DoubleConvCond block 206 to concatenate the conditioning motion latent code m to the results of the sub-blocks of the DoubleConv block 202. The input channel size of the fifth DoubleConvCond block 206 is 2048, the output channel size of the fifth DoubleConvCond block 206 is 2048.

The sixth and seventh blocks of the U-Net-based diffusion predictor are each the same as the above described DoubleConvCond block 206. Thus, the description of contents of the blocks is omitted herein. The input channel size of the sixth DoubleConvCond block 206 is 2048, the output channel size of the sixth DoubleConvCond block 206 is 2048. The input channel size of the seventh DoubleConvCond block 206 is 2048, the output channel size of the seventh DoubleConvCond block 206 is 2048.

The eighth block of the U-Net-based diffusion predictor, which is namely the (4) UpCondBlock block 208, operates on the output of the seventh block and additionally on the motion latent code m and the current diffusion timestep index t drawn into the UpCondBlock block 208 via sine and/or cosine positional encoding. The UpCondBlock block 208 comprises a sub-block of sigmoid linear unit (SiLU) activation function and a sub-block of DoubleConvCond and DoubleConv, which contents respectively correspond to the contents of the DoubleConvCond block 206 and DoubleConv block 202 described above. The resulted data of the sub-blocks are summed up and passed to the next block of the U-Net-based diffusion predictor. The input channel size of the eighth UpCondBlock block 208 is 4096, the output channel size of the eighth UpCondBlock block 208 is 512.

The ninth and tenth blocks of the U-Net-based diffusion predictor are each the same as the above described UpCondBlock block 208. Thus, the description of contents of the blocks is omitted herein. The input channel size of the ninth UpCondBlock block 208 is 1024, the output channel size of the ninth UpCondBlock block 208 is 256. The input channel size of the tenth UpCondBlock block 208 is 512, the output channel size of the tenth UpCondBlock block 208 is 64.

The last block of the U-Net-based diffusion predictor, which is namely the 64->4 block 210, is the fully connected block with 1×1 2D convolution (Conv2d).

Training procedure applied to the diffusion-based frame-to-next-frame model is described below in the following Pseudocode 1:

```
  Pseudocode 1: the diffusion-based frame-to-next-frame model training
procedure (without loss of generality it is assumed here that batch size is
equal to 1)
  repeat
  $Sample : {I}_{n}^{i} and {I}_{n}^{i + d}$
  ${x}^{i} - E ( {I}_{n}^{i} ) , {x}^{i + d} = E ( {I}_{n}^{i + d} ) ,$
  ${r}_{0}^{i + d} = {x}^{i + d} - {x}^{i}$
  m = e(n)
    t~Uniform(1, ... ,T)
  ϵ~ [symbol]   (0, I)
```

Take gradient descent step on

$${∇}_{θ , e} {‖ ϵ - {f}_{θ} ( \sqrt{{α}_{t}} {r}_{0}^{i + d} + \sqrt{1 - {α}_{t}} ϵ , {x}^{i} , m , t ) ‖}^{2}$$

until Converged (i.e., until the global optimum value of the loss function is obtained)
where α̅ₜ is a hyperparameter of f_{θ}.

The diffusion-based frame-to-next-frame model may be trained not on entire frames but on crops of the frames. In a particular non-limiting implementation the diffusion-based frame-to-next-frame model is trained on 5 crops of each of one or more frames of one or more full-resolution training videos comprised in a training dataset: the center and four corners, to make the motion latent representations robust. These 5 crops share the same motion latent code. This helps to reduce the dependence on the spatial arrangement of moving pixels in the video. In addition, the motion diversity of the training dataset may optionally be increased through augmentations: horizontal flip and time inversion applied to training frames/crops. The result is a 4-fold increase in the number of unique motion latent. Once f_{θ} is trained, the bank M of learned motion embeddings stored in motion embedding layer e is obtained. The motion embedding layer e is an array of vectors from which the desired embedding is obtained by the video index. Initially, for each video, the vector is initialized randomly. At each iteration of training, one vector m is taken from the array by index, corresponding to the video whose frames participate in this iteration. Next, m participates in the diffusion process and is updated by gradient descent like all other weights.

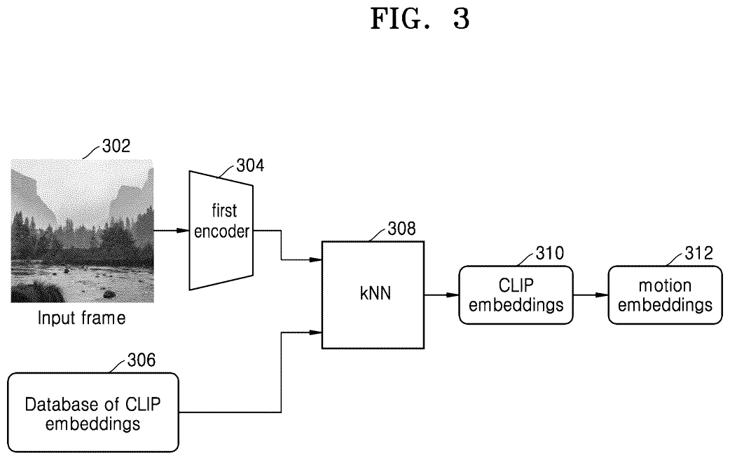

FIG. 3 illustrates motion latent code sampling process performed by the diffusion-based frame-to-next-frame model according to an embodiment of the disclosure.

In a particular non-limiting embodiment of the shared motion latent code sampling scheme obtaining the shared motion latent code m by a first encoder. In an embodiment of the disclosure, the first encoder 304 includes contrastive language-image pretraining (CLIP) encoder. In an embodiment of the disclosure, the shared motion latent code m is used at inference of the diffusion-based frame-to-next-frame model for conditioning the dynamics of motion to be reflected in synthesized frames contrastive language-image pretraining (CLIP) approach is used as illustrated in FIG. 3. However, the disclosure should not be limited to the usage of CLIP, because to compare frame content it is possible to use various pre-trained image encoders. The shared motion latent code m has to be selected properly to drive the direction and nature of the movement in the video being synthesized. A naive approach is to sample motion latent code m from one or more motion latent codes of random videos, which are stored in the bank M of learned motion embeddings 312. However, it was found that synthesizing an image while conditioning it with the motion latent code m sampled from a drastically different video in terms of the content, i.e., in this case motion latent code m will not be the shared one, may lead to visual artifacts, unrealistic movements, and unnaturally looking objects. Frame embedding is a set of feature maps obtained by E from a frame, and motion embeddings 312 is a vector obtained from an array of learnable vectors M by video index.

Referring to FIG. 3 depicted is the shared motion latent code m sampling scheme, according to which the motion latent code m of the videos with the closest CLIP scores is reused as the shared motion latent code m. This results in smoother and more coherent video synthesis/animations. As illustrated in FIG. 3 to obtain the shared motion latent code m for a frame of a video being synthesized it is proposed first to obtain CLIP embedding for the frame by passing the frame through an encoder of the trained CLIP neural network that is known from the prior art as the OpenAI product. Then one or more CLIP embeddings 310 nearest to the obtained CLIP embedding is/are searched using k-nearest neighbors (kNN) 308 on the database of CLIP embeddings 306 obtained in advance for one or more frames of one or more training videos comprised in the training dataset used for training the diffusion-based frame-to-next-frame model. kNN 308 was chosen as the primary algorithm used herein, because it is the easiest to implement. However, the disclosure should not be limited to the usage of kNN 308, because any available more complex algorithms may be used in the disclosure as well. CLIP embeddings 310 may be obtained and stored in the database of CLIP embeddings 306 in advance to not re-calculate the CLIP embeddings 310 each inference time. Finally, the shared motion latent code is obtained from the bank of learned motion embeddings 312 corresponding to one or more frames of the one or more training videos that were used to obtain the one or more found CLIP embeddings 310. In a particular non-limiting embodiment the shared motion latent code m of one or more starting frames of the one or more training videos that were used to obtain the one or more nearest CLIP embeddings 310 is reused as the shared motion latent code m. A starting frame may be the input frame 302. In an embodiment of the disclosure, averaging may be applied to shared motion latent codes of the one or more training videos that were used to obtain the one or more nearest CLIP embeddings 310 and the averaged motion latent code m may be used as the shared motion latent code m.

Inference procedure carried out by the trained diffusion-based frame-to-next-frame model is described below in the following Pseudocode 2:

```
  Pseudocode 2: Inference procedure by the trained diffusion-based
frame-to-next-frame model
  Input I⁰ - starting frame.
  Select shared motion latent code m from the bank M of learned motion
embeddings 312 (as described with reference to FIG. 3 above)
    x⁰ = E(I⁰)
    for i = (1, ... , N) do
      ${r}_{T}^{i} \sim 𝒩 ( 0 , I )$
      for t = (T, ... ,1) do
        $args = ( {r}_{t}^{i} , {x}^{i - 1} , m , t )$
        ${r}_{t - 1}^{i} = \frac{1}{\sqrt{{α}_{t}}} ( {r}_{t}^{i} - \frac{1 - {α}_{t}}{\sqrt{1 - {α}_{t}}} {f}_{θ} ( args ) )$
      end for
      ${x}^{i} = {x}^{i - 1} + {r}_{0}^{i}$
        Iⁱ = D(xⁱ)
      end for
Return: V = {I}^{N}
```

Thus, f_{θ} is used at inference to generate a video sequence V={I}^{N} given the starting (conditioning) frame I⁰ in an autoregressive way. Since the diffusion-based frame-to-next-frame model is fully convolutional, advantageously it is possible to use at inference the starting frame of higher resolution than that of frames used at training of said model.

The method of synthesizing a video as described above may be performed by an electronic device (not shown). Such a device may be, but not limited to, a smartphone, a tablet, a notebook, personal computer (PC), augmented reality (AR)/virtual reality (VR) headset and so on. The electronic device may at least comprise a processor and memory storing computer-executable instructions which when executed by the processor cause the device to perform the method according to the first aspect or according to any development of the first aspect. The memory may further directly store weights and offsets of the diffusion-based frame-to-next-frame model including the U-Net-based diffusion predictor and VAE. In addition, the memory may further directly store weights and offsets of CLIP neural network.

Alternatively, the electronic device equipped with a communication unit may send a request to one or more servers executing the diffusion-based frame-to-next-frame model including the U-Net-based diffusion predictor and VAE and the CLIP neural network to receive in response to the request one or more, or all externally synthesized frames of video sequence(s). In this case, the technical solutions proposed and described herein may be implemented on such one or more computer-implemented servers. Moreover, training of the diffusion-based frame-to-next-frame model including the U-Net-based diffusion predictor and VAE and, if necessary, of the CLIP-based model may be online (i.e., be executed on the device itself) or offline (i.e., be executed by one or more external servers).

The processor may be of any type, e.g., it may include, but without any limitation, one or more of a central processing unit (CPU), a digital signal processor (DSP), an application processor (AP), a graphics-processing unit (GPU), a vision processing unit (VPU), a dedicated AI processor, such as a neural processing unit (NPU) and so on. The processor may be implemented as system-on-chip (SOC), application specific integrated circuit (ASIC), field programmable gate array (FPGA), or other programmable logic device (PLD), discrete logic element, transistor logic, discrete hardware components, or any combination thereof.

The memory may be of any type, e.g., it may include, but without any limitation, one or more of random access memory (RAM), video random access memory (VRAM), dynamic RAM (DRAM), static RAM (SRAM), double data rate SDRAM (DDR SRAM), double data rate 4 synchronous dynamic RAM (DDR4 RAM), Rambus dynamic RAM (DRDRAM), read-only memory (ROM), programmable ROM (PROM), erasable PROM (EPROM), electrically erasable PROM (EEPROM), virtual memory. The memory may be implemented as solid-state drive (SSD), hard disk drive (HDD), USB flash drive and so on.

The electronic device may operate on any operating system (e.g., Android, iOS, Harmony OS, Windows, Linux, or the like) and may include any other necessary software, firmware, and/or hardware (e.g., a communication unit, input/output (I/O) interface, a camera (e.g., to capture the staring frame I⁰), a power supply and so on). Non-limiting examples of computing device 50 include a smartphone, a smartwatch, a tablet, a hearing aid device, a computer, a notebook, AR/VR headset and so on.

The application also provides a computer-readable (non-transitory) medium storing computer-executable instructions which when executed by a device cause the device to perform the method (or function as the device performing the method) according to the first aspect or according to any development of the first aspect. Any types of media or storage devices may be used as the computer-readable medium.

Experimental data and other non-limiting features of the proposed technical solutions. Provided below are quantitative and qualitative experiment results. The flagship model was trained on the DeepLandscape dataset. The dataset consists of 999 training landscape videos in 1280×720 resolution in a training split and 57 testing videos. For comparison with quantitative existing solutions for image-to-video generation, the diffusion-based frame-to-next-frame model proposed and disclosed herein was trained and evaluated on the SkyTimelapse dataset of clips of different length containing dynamic sky scenes. It contains 35392 training video clips and 2815 testing video clips in 640×360 resolution. The scenes include different daytime and weather conditions. Both diffusion-based frame-to-next-frame models were trained on Nvidia A100 80 GB GPU (X4 GPUs for DeepLandscape dataset) with a batch size of 256 and AdamW optimizer with the learning rate set to 5×10⁻⁵. The SkyTimelapse models were trained on 256×256 crops, and DeepLandscape models—on 512×512 crops. In all experiments, the video time delta d was set to 1 and the model was trained for 150K epochs, where one epoch is one full pass through a dataset.

Quantitative results are given in below Table 1: Quantitative results of image-to-video generation quality and diversity on SkyTimelapse dataset:

TABLE 1

| | | | | | DIV | DIV |
|---|---|---|---|---|---|---|
| Method | LPIPS↓ | FID↓ | DTFVD↓ | FVD↓ | VGG ↑ | I3D↑ |
| MDGAN | 0.49 | 68.9 | 2.35 | 385.1 | — | — |
| DTVNet | 0.35 | 74.5 | 2.78 | 693.4 | 0.00 | 0.00 |
| DL | 0.41 | 41.1 | 1.73 | 351.5 | — | — |
| AL | 0.26 | 16.4 | 1.24 | 307.0 | 0.97 | 0.71 |
| CINN | 0.23 | 10.5 | 0.59 | 134.4 | 0.71 | 1.22 |
| the diffusion- | 0.29 | 21.7 | 0.79 | 191.9 | 1.28 | 1.32 |
| based frame- | | | | | | |
| to-next-frame | | | | | | |
| model proposed | | | | | | |
| and disclosed | | | | | | |
| herein | | | | | | |

Conditional Video Generation. The quality of synthesized frames was evaluated via learned perceptual image patch similarity (LPIPS) and FID. For video quality assessment, reported are FVD and DTFVD, which is helpful to measure other types of dynamics not captured by FVD. Further, the diversity of generated videos was measured by DIV VGG and DIV I3D. Since the diffusion-based frame-to-next-frame model is able to generate several different videos from a given initial frame, both metrics measure their average mutual distance in the feature space of a VGG-16 and I3D networks pre-trained on ImageNet and Kinetics respectively. To compare fairly with competitors, metrics calculation methods were adopted from Michael Dorkenwald, Timo Milbich, Andreas Blattmann, Robin Rombach, Konstantinos G. Derpanis, and Bjorn Ommer “Stochastic image-to-video synthesis using cinns” in Proceedings of the IEEE/CVF conference on computer vision and pattern recognition (CVPR), 2021. Evaluation was performed on the videos of 128×128 resolution and 32 frames long.

It is seen from the results given in the above Table 1, that while the diffusion-based frame-to-next-frame model proposed and disclosed herein achieves comparable quality to that of the competitors, it generates more diverse videos and significantly outperforms the other models according to both diversity metrics. Moreover, unlike existing approaches, diffusion-based frame-to-next-frame model can produce videos in higher resolutions than the videos in the training set.

Unconditional video generation. Even though most of the video generation models address unconditional video generation tasks, it is important to compare the results achieved by the diffusion-based frame-to-next-frame model with them. For that, in the experiments the first frame was generated with the StyleGAN-V generator and then animated with the diffusion-based frame-to-next-frame model proposed and disclosed herein. These experiments were conducted on the SkyTimelapse dataset as well. 162 generated videos with a resolution of 256×256 and a length of 16 and 128 frames were assessed. Obtained quantitative results of unconditional video generation quality on SkyTimelapse dataset are reported in the below Table 2:

TABLE 2

| Method | FVD-16↓ | FVD-128↓ |
|---|---|---|
| DIGAN | 83.11 | 196.7 |
| StyleGAN-V | 79.52 | 197.0 |
| the diffusion-based frame-to- | 67.85 | 193.2 |
| next-frame model proposed | | |
| and disclosed herein + StyleG | | |
| AN-V starting frame | | |

The results given in the above Table 2 demonstrate that with the same initial frames, the diffusion-based frame-to-next-frame model generates better videos in terms of FVD than StyleGAN-V. Moreover, the advantage remains for videos of 128 frames, although the diffusion-based frame-to-next-frame model is autoregressive compared to the competitor.

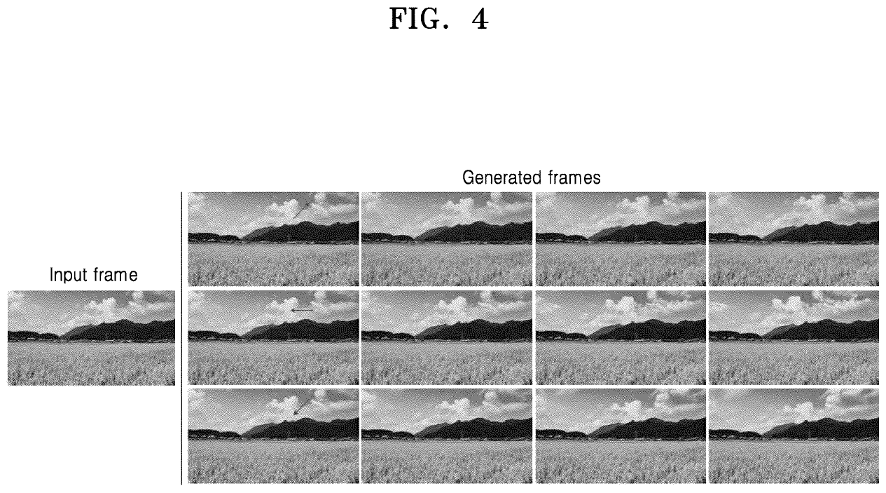

FIG. 4 illustrates frames synthesized in an autoregressive way starting from an input frame with the diffusion-based frame-to-next-frame model according to an embodiment of the disclosure.

Illustrated on FIG. 4 are examples for different frame sequences generated for a single input frame by the diffusion-based frame-to-next-frame model trained on DeepLandscape dataset in 1280×704 resolution. Demonstrated are the 1st, 6th, 11th and 16th generated frames. Using different motion latent codes from the bank M of learned motion embeddings 312, the direction and nature of the motion on the video are modifiable.

In favor of high-resolution video generation and due to memory limitations, self-attention layers originally used in DDPMs are eliminated from the proposed diffusion-based frame-to-next-frame model. This makes the proposed diffusion-based frame-to-next-frame model fully convolutional and enables generating videos of higher resolution than the ones the model was trained on. The experiments conducted by authors of the disclosure reveal that this simplification does not bring any quality loss. Metrics also confirm that utilizing style modulation (with the shared motion latent code m) for conditioning is comparable to the cross-attention technique which is popular for diffusion models. However, advantageously, style modulation is more memory efficient than cross-attention and keeps the diffusion-based frame-to-next-frame model fully convolutional.

The diffusion-based frame-to-next-frame model is trained using a number of crops (e.g., 5 crops) of the video with shared motion latent code. This type of data augmentation regularizes the model and prevents dependence of learned motion latent codes on the spatial regions of the training frames. The model trained on one center crop generates separate frames of good quality, but video consistency suffers. This can be seen in the considerable FVD and diversity metrics increase. It is also shown that the kNN-based shared motion latent code sampling scheme increases video quality and diversity compared to the random sampling of the motion latent code.

Thus, disclosed in the application is a new class of video-diffusion models that generated videos in 2 times higher resolution than current state-of-the-art approaches achieving comparable video quality on small-scale video datasets. It has been shown that recursive frame sampling combined with a shared style/motion conditioning vector m leads to better temporal coherence in data and resource-limited settings compared to more complex known architectures. The proposed architecture of the diffusion-based frame-to-next-frame model with a limited number of parameters can achieve high visual quality at large resolutions without training on proprietary large-scale video datasets opens new possibilities in generative video research and development regarding even more efficient models that apply alternative techniques to the popular and computationally expensive temporal attention and temporal convolution. It has been also acknowledged herein that the simple content-matching scheme using a pre-trained image encoder E significantly improves the visual appeal of synthesized videos by selecting the shared motion latent codes that produce smoother animations without over-reliance on the semantic layouts of specific videos.

The purpose of this disclosure is to address various technical problems, which are not restricted solely to the ones mentioned earlier. Any other technical problems not explicitly stated here will be readily understood by those skilled in the art from the following disclosure.

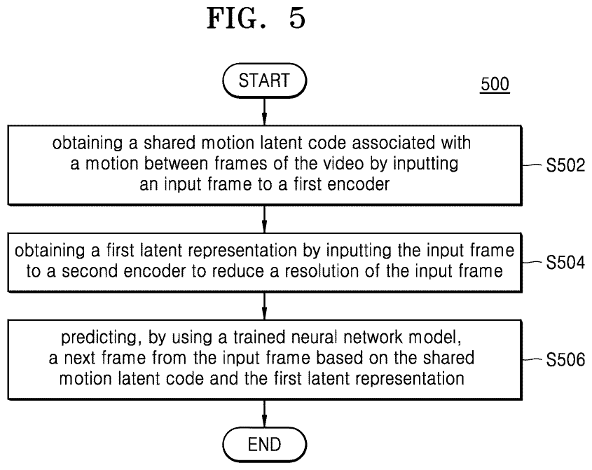

FIG. 5 illustrates a method 500 for synthesizing video according to an embodiment of the disclosure.

Referring to FIG. 5, in an embodiment of the disclosure, at operation S502, a method may include obtaining a shared motion latent code corresponding to a motion between frames of the video by inputting an input frame to a first encoder. At operation S504, the method may include obtaining a first latent representation by inputting the input frame to a second encoder to reduce a resolution of the input frame. At operation S506, the method may include predicting, by using a trained neural network model, a next frame from the input frame based on the shared motion latent code and the first latent representation

In an embodiment of the disclosure, the first encoder includes a contrastive language-image pretraining (CLIP) encoder, wherein the second encoder includes pre-trained variational autoencoder (VAE), wherein the trained neural network model includes a U-Net-based diffusion predictor.

In an embodiment of the disclosure, the method includes predicting, by using the trained neural network model, one more next frame from the previously predicted next frame based on the shared motion latent code and the first latent representation.

In an embodiment of the disclosure, the motion between the frames of the video being synthesized is based on the shared motion latent code by inputting the shared motion latent code to one or more layers of the trained neural network model.

In an embodiment of the disclosure, the method includes obtaining a contrastive language-image pretraining (CLIP) embedding for the input frame by inputting the input frame to the first. The method includes identifying one or more CLIP embeddings nearest to the obtained CLIP embedding using a k-nearest neighbors (kNN) and a distance metric for the kNN, based on a database of CLIP embeddings obtained for one or more frames of one or more training videos comprised in a training dataset used for training the neural network model. The method includes obtaining the shared motion latent code from a motion embeddings corresponding to one or more frames of the one or more training videos that were used to obtain the one or more CLIP embeddings.

In an embodiment of the disclosure, the distance metric for the kNN is computed as the distance of the CLIP embedding of a frame of a training video comprised in the training dataset and the CLIP embedding of the input frame.

In an embodiment of the disclosure, the method includes obtaining a pair of frames including the input frame and the next frame from a training video of a training dataset. The method includes obtaining the first latent representation and a second latent representation of the pair of frames by inputting the pair of frames to the second encoder. The method includes computing a residual by subtracting the first latent representation from the second latent representation. The method includes obtaining the shared motion latent code of the training video indicated by the index, from which the pair of frames are obtained, and storing the obtained shared motion latent code to the database of CLIP embeddings. The method includes obtaining a diffusion timestep index corresponding to the ordinal of the diffusion timesteps, wherein the diffusion timestep index is drawn into the neural network model based on sine or cosine function. The method includes obtaining a sampled noise tensor by sampling a noise tensor based on a normal distribution. The method includes obtaining a predicted noise tensor based on the shared motion latent code, the diffusion timestep index, the first latent representation, and the residual. The method includes updating, based on the sampled noise tensor, the predicted noise tensor, weights of the neural network model.

In an embodiment of the disclosure, the method includes obtaining the predicted noise tensor by inputting the shared motion latent code, the diffusion timestep index, the first latent representation, and the computed residual to the neural network model.

In an embodiment of the disclosure, the pair of frames obtained from the training video are frames located adjacently or near to each other in the sequence of frames of the training video. The method includes minimizing a loss function between the predicted noise tensor and the sampled noise tensor by using a gradient descent.

In an embodiment of the disclosure, the method includes obtaining crops of each of the pair of frames including a center and one or more of four corners of the pair of frames. The method includes obtaining the first latent representations and the second latent representation of the pair of frames by inputting the pair of frames to the second encoder in the form of the crops of the pair of frames.

In an embodiment of the disclosure, the method includes obtaining additional pairs of frames by performing at least one of horizontal flip or time inversion of the pair of frames from the training video of the training dataset. The method includes obtaining the CLIP embedding for the input frame. The method includes identifying one or more CLIP embeddings nearest to the obtained CLIP embedding using kNN, based on the database of the CLIP embeddings obtained previously for one or more training videos comprised in the training dataset used for training the neural network model. The method includes obtaining the shared motion latent code based on a bank of learned motion embeddings corresponding to one or more frames of the one or more training videos that were used to obtain the one or more CLIP embeddings. The method includes obtaining the first latent representation by inputting the input frame to the second encoder. The method for each frame in the video being synthesized by using the trained neural network model starting with the next frame includes: obtaining an initial noised residual, obtaining a denoised residual by performing steps of a diffusion by the trained neural network model, wherein for each the steps of the diffusion include subtracting from a noised residual an output value of the trained model, obtaining the second latent representation of a next frame by adding the denoised residual to the first latent representation of the input frame, obtaining the next frame by inputting the second latent representation to a decoder corresponding to the second encoder and obtaining the synthesized video by concatenating all obtained frames.

In an embodiment of the disclosure, a method of synthesizing a video (a sequence of frames) in an autoregressive way includes: predicting with the use of a trained diffusion-based frame-to-next-frame model a next frame

$${I}_{n}^{i + d}$$

from an input frame

$${I}_{n}^{i}$$

while conditioning motion between the frames of the video being synthesized with a shared motion latent code m.

In an embodiment of the disclosure, the method further includes predicting with the use of the trained diffusion-based frame-to-next-frame model one more next frame from the previously predicted frame

$${I}_{n}^{i + d}$$

while still conditioning motion between the frames of the video being synthesized with said shared motion latent code m.

In an embodiment of the disclosure, motion between the frames of the video being synthesized is conditioned (explicitly controlled) with the shared motion latent code m by inputting said shared motion latent code m to one or more layers of a U-Net-based diffusion predictor of the diffusion-based frame-to-next-frame model.

In an embodiment of the disclosure, the shared motion latent code m is obtained by performing the steps of: obtaining contrastive language-image pretraining (CLIP) embedding for the input frame

$${I}_{n}^{i}$$

by passing the input frame

$${I}_{n}^{i}$$

through an encoder of the trained CLIP neural network, searching for one or more CLIP embeddings nearest to the obtained CLIP embedding using k-nearest neighbors (kNN), the search is carried out on a database of CLIP embeddings obtained for one or more frames of one or more training videos comprised in a training dataset used for training the diffusion-based frame-to-next-frame model, and sampling the shared motion latent code m from a bank M of learned motion embeddings corresponding to one or more frames of the one or more training videos that were used to obtain the one or more found CLIP embeddings.

In an embodiment of the disclosure, the distance metric for the kNN is computed as the distance from CLIP embedding of a frame of a training video comprised in the training dataset to the CLIP embedding of the input frame

$${I}_{n}^{i} .$$

In an embodiment of the disclosure, the diffusion-based frame-to-next-frame model is trained by repeatedly performing the following steps until convergence: randomly sampling a pair of frames

$${I}_{n}^{i} and {I}_{n}^{i + d}$$

from a training video of the training dataset, where d denotes the video time delta between the frames, passing the frames

$${I}_{n}^{i} and {I}_{n}^{i + d}$$

through an encoder E of a pre-trained variational autoencoder (VAE) to obtain respective latent representations xⁱ and x^{i+d} of the frames, computing residual

$${r}_{0}^{i + d}$$

by subtracting the latent representation xⁱ from the latent representation x^{i+d}, obtaining the shared motion latent code m of the training video indicated by the index n, from which the frames

$${I}_{n}^{i} and {I}_{n}^{i + d}$$

are sampled, and storing the obtained shared motion latent code m to the database of learnable motion embeddings, randomly sampling the diffusion timestep index t corresponding to the ordinal of the diffusion timesteps from 1 To T, where T is the total number of diffusion timesteps and the diffusion timestep index t is drawn into the diffusion-based frame-to-next-frame model via sine and/or cosine positional encoding, randomly sampling a noise tensor ϵ from N(0,I), and updating weights of the U-Net-based diffusion predictor comprised in the diffusion-based frame-to-next-frame model by taking a gradient descent step on the L2 loss between sampled noise tensor ϵ and noise tensor ϵ predicted by the U-Net-based diffusion predictor conditioned on the sampled shared motion latent code m, the diffusion timestep index t, the latent representation xⁱ, and computed residual

$${r}_{t}^{i + d} .$$

In an embodiment of the disclosure, at diffusion timestep t for frame

$${I}_{n}^{i}$$

the predicted noise tensor ϵ is obtained by passing through the U-Net-based diffusion predictor the sampled shared motion latent code m, the diffusion timestep index t, the latent representation xⁱ, and computed residual

$${r}_{t}^{i + d}$$

noised with the randomly sampled noise tensor ϵ.

In an embodiment of the disclosure, the two frames

$${I}_{n}^{i} and {I}_{n}^{i + d}$$

sampled from the training video are frames located adjacently or near to each other in the sequence of frames of the training video, the diffusion-based frame-to-next-frame model conditioned on the sampled shared motion latent code m, the diffusion timestep index t, the latent representation xⁱ, and computed residual

$${r}_{t}^{i + d}$$

is trained by minimizing the L2 loss between the predicted noise tensor ϵ and the sampled noise tensor ϵ.

In an embodiment of the disclosure, the two frames

$${I}_{n}^{i} and {I}_{n}^{i + d}$$

that are passed through the encoder E of the pre-trained VAE to obtain respective latent representations xⁱ and x^{i+d} of the frames are passed in the form of crops of said frames, wherein the method further comprising the step of obtaining said crops from each of the frames, the crops of each of the frames include the center and one or more of four corners of the frame.

In an embodiment of the disclosure, the method further include one or more steps of obtaining additional pairs of frames to be used at the training stage by performing horizontal flip and/or time inversion of frame pairs randomly sampled from training videos comprised in the training dataset.

In an embodiment of the disclosure, predicting the next frame Iⁱ from the preceding frame I^{t-1} with the use of the trained diffusion-based frame-to-next-frame model while conditioning motion between the frames of the video being synthesized with the shared motion latent code m includes the steps of: obtaining CLIP embedding for the preceding frame I^{t-1}, searching for one or more CLIP embeddings nearest to the obtained CLIP embedding using kNN, the search is carried out on the database of CLIP embeddings obtained previously for one or more frames of one or more training videos comprised in the training dataset used for training the diffusion-based frame-to-next-frame model, sampling the shared motion latent code m from a bank M of learned motion embeddings corresponding to one or more frames of the one or more training videos that were used to obtain the one or more found CLIP embeddings, passing the preceding frame I^{t-1} through the encoder E of the pre-trained VAE to obtain respective latent representation xⁱ⁻¹, for each frame in the video being synthesized with the trained diffusion-based frame-to-next-frame model starting with the second frame sampling the initial noised residual

$${r}_{r}^{i}$$

from N(0,I), obtaining the denoised residual

$${r}_{0}^{i}$$

by performing T steps of diffusion by the U-Net-based diffusion predictor, wherein at step t of diffusion subtracting from the noised residual of the output value of the trained U-Net-based diffusion predictor comprised in the diffusion-based frame-to-next-frame model

$$( 1 - {α}_{t} ) / ( sqrt ( 1 - {α}_{t} ) ) * {f}_{θ} ( {r}_{t}^{i} , {x}^{i - 1} , m , t ) ,$$

where αₜ is a hyperparameter of the trained U-Net-based diffusion predictor, obtaining the latent representation xⁱ of a synthesized next frame Iⁱ by adding the denoised residual

$${r}_{0}^{i}$$

to the latent representation xⁱ⁻¹ of the previous frame, obtaining the synthesized next frame Iⁱ by passing the latent representation xⁱ of said frame through a decoder of the pre-trained VAE, and obtaining the synthesized video V by concatenating all synthesized frames {I}^{N}.

In all materials of the application, the reference to an element in the singular does not exclude the presence of a plurality of such elements in an actual implementation of the disclosure, and, vice versa, the reference to an element in the plural does not exclude the presence of only one such element in an actual implementation of the disclosure. Any particular value or range of values indicated above is not to be interpreted in a limiting sense, but instead such a particular value or range of values are to be considered as representing a midpoint of a certain greater range, up to approximately 50% at both sides of the specified value or specifically indicated smaller range.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method for synthesizing a video, the method comprising:
obtaining a shared motion latent code corresponding to a motion between frames of the video by inputting an input frame to a first encoder;
obtaining a first latent representation by inputting the input frame to a second encoder to reduce a resolution of the input frame; and
predicting, by using a trained neural network model, a next frame from the input frame based on the shared motion latent code and the first latent representation.

2. The method of claim 1,
wherein the first encoder includes a contrastive language-image pretraining (CLIP) encoder,
wherein the second encoder includes pre-trained variational autoencoder (VAE), and
wherein the trained neural network model includes a U-Net-based diffusion predictor.

3. The method of claim 1, wherein the predicting of the next frame includes:
predicting, by using the trained neural network model, one more next frame from a previously predicted next frame based on the shared motion latent code and the first latent representation.

4. The method of claim 1, wherein the motion between the frames of the video being synthesized is based on the shared motion latent code by inputting the shared motion latent code to one or more layers of the trained neural network model.

5. The method of claim 1, wherein the obtaining of the shared motion latent code includes:
obtaining a contrastive language-image pretraining (CLIP) embedding for the input frame by inputting the input frame to the first encoder;
identifying one or more CLIP embeddings nearest to the obtained CLIP embedding using a k-nearest neighbors (kNN) and a distance metric for the kNN, based on database of CLIP embeddings obtained for one or more frames of one or more training videos comprised in a training dataset used for training the neural network model; and
obtaining the shared motion latent code from a bank of learned motion embeddings corresponding to one or more frames of the one or more training videos that were used to obtain the one or more CLIP embeddings.

6. The method of claim 5, wherein the distance metric for the kNN is computed as the distance of the CLIP embedding of a frame of a training video comprised in the training dataset and the CLIP embedding of the input frame.

7. The method of claim 6, wherein the trained neural network model is trained by repeatedly performing:
obtaining a pair of frames including the input frame and the next frame from a training video of a training dataset;
obtaining the first latent representation and a second latent representation of the pair of frames by inputting the pair of frames to the second encoder;
computing a residual by subtracting the first latent representation from the second latent representation;
obtaining the shared motion latent code of the training video indicated by an index, from which the pair of frames are obtained, and storing the obtained shared motion latent code to the database of CLIP embeddings;
obtaining a diffusion timestep index corresponding to an ordinal of diffusion timesteps, wherein the diffusion timestep index is drawn into the neural network model based on sine or cosine function;
obtaining a sampled noise tensor by sampling a noise tensor based on a normal distribution;
obtaining a predicted noise tensor based on the shared motion latent code, the diffusion timestep index, the first latent representation, and the residual; and
updating, based on the sampled noise tensor, the predicted noise tensor, weights of the neural network model.

8. The method of claim 7, wherein the obtaining of the predicted noise tensor includes:
obtaining the predicted noise tensor by inputting the shared motion latent code, the diffusion timestep index, the first latent representation, and a computed residual to the neural network model.

9. The method of claim 7,
wherein the pair of frames obtained from the training video are frames located adjacently or near to each other in a sequence of frames of the training video, and
wherein the updating the weights of the neural network model includes minimizing a loss function between the predicted noise tensor and the sampled noise tensor by using a gradient descent.

10. The method of claim 7, wherein the obtaining of the first latent representation and the second latent representation includes:
obtaining crops of each of the pair of frames including a center and one or more of four corners of the pair of frames; and
obtaining the first latent representations and the second latent representation of the pair of frames by inputting the pair of frames to the second encoder in a form of the crops of the pair of frames.

11. The method of claim 7, wherein the obtaining of the pair of frames further includes:
obtaining additional pairs of frames by performing at least one of horizontal flip or time inversion of the pair of frames from training videos comprised in the training dataset.

12. The method of claim 11, wherein the predicting of the next frame from the input frame includes:
obtaining a CLIP embedding for the input frame;
identifying one or more CLIP embeddings nearest to the obtained CLIP embedding using kNN, based on the database of the CLIP embeddings obtained previously for one or more training videos comprised in a training dataset used for training the neural network model;
obtaining the shared motion latent code based on a bank of learned motion embeddings corresponding to one or more frames of the one or more training videos that were used to obtain the one or more CLIP embeddings;
obtaining the first latent representation by inputting the input frame to the second encoder;
for each frame in the video being synthesized by using the trained neural network model starting with the next frame:
obtaining an initial noised residual;
obtaining a denoised residual by performing steps of a diffusion by the trained neural network model, wherein for each the steps of the diffusion include: subtracting from a noised residual an output value of the trained model;
obtaining the second latent representation of a next frame by adding the denoised residual to the first latent representation of the input frame;
obtaining the next frame by inputting the second latent representation to a decoder corresponding to the second encoder; and
obtaining a synthesized video by concatenating all obtained frames.

13. An electronic device for synthesizing a video, the electronic device comprising:
memory, comprising one or more storage media, storing instructions; and
at least one processor communicatively coupled to the memory,
wherein the instructions, when executed individually or collectively by the at least one processor, cause the electronic device to:
obtain a shared motion latent code associated with a motion between frames of the video by inputting an input frame to a first encoder,
obtain a first latent representation by inputting the input frame to a second encoder to reduce a resolution of the input frame, and
predict, by using a trained neural network model, a next frame from the input frame based on the shared motion latent code and the first latent representation.

14. The electronic device of claim 13,
wherein the first encoder includes a contrastive language-image pretraining (CLIP) encoder,
wherein the second encoder includes pre-trained variational autoencoder (VAE), and
wherein the trained neural network model includes a U-Net-based diffusion predictor.

15. The electronic device of claim 13, wherein the instructions, when executed individually or collectively by the at least one processor, further cause the electronic device to:
predict, by using the trained neural network model, one more next frame from a previously predicted next frame based on the shared motion latent code and the first latent representation.

16. The electronic device of claim 13, wherein the motion between the frames of the video being synthesized is based on the shared motion latent code by inputting the shared motion latent code to one or more layers of the trained neural network model.

17. The electronic device of claim 13, wherein the instructions, when executed individually or collectively by the at least one processor, further cause the electronic device to:
obtain a contrastive language-image pretraining (CLIP) embedding for the input frame by inputting the input frame to the first encoder,
identify one or more CLIP embeddings nearest to the obtained CLIP embedding using a k-nearest neighbors (kNN) and a distance metric for the kNN, based on a database of CLIP embeddings obtained for one or more frames of one or more training videos comprised in a training dataset used for training the neural network model, and
obtain the shared motion latent code from a bank of learned motion embeddings corresponding to one or more frames of the one or more training videos that were used to obtain the one or more CLIP embeddings.

18. The electronic device of claim 17, wherein the distance metric for the kNN is computed as the distance of the CLIP embedding of a frame of a training video comprised in the training dataset and the CLIP embedding of the input frame.

19. One or more non-transitory computer-readable storage media storing one or more computer programs including computer-executable instructions that, when executed by individually or collectively by at least one processor of an electronic device cause the electronic device to perform operations, the operations comprising:
obtaining a shared motion latent code corresponding to a motion between frames of a video by inputting an input frame to a first encoder;
obtaining a first latent representation by inputting the input frame to a second encoder to reduce a resolution of the input frame; and
predicting, by using a trained neural network model, a next frame from the input frame based on the shared motion latent code and the first latent representation.

20. The one or more non-transitory computer-readable storage media of claim 19,
wherein the first encoder includes a contrastive language-image pretraining (CLIP) encoder,
wherein the second encoder includes pre-trained variational autoencoder (VAE), and
wherein the trained neural network model includes a U-Net-based diffusion predictor.
